(19) United States
(12) Patent Application Publication
(10) Pub. No.: US 2004/0030881 A1
(43) Pub. Date: Feb. 12, 2004

(54) Method, system, and computer program product for improved reboot capability

(75) Inventors: Bradley Ryan Harrington, Austin, TX (US); Ajay Kumar Mahajan, Austin, TX (US); Chetan Mehta, Austin, TX (US); Milton Devon Miller II, Austin, TX (US); Michael Anthony Perez, Cedar Park, TX (US); Peter Dinh Phan, Austin, TX (US); David R. Willoughby, Austin, TX (US)

Correspondence Address: Mark D. Simpson, Esq., SYNNESTVEDT & LECHNER LLP, Suite 2600 Aramark Tower, 1101 Market Street, Philadelphia, PA, 19107, US

(73) Assignee: International Business Machines Corp., Armonk, NY (US)

(21) Appl. No.: 10/216,629

(22) Filed: Aug. 8, 2002

(51) Int. Cl. G06F 9/445

(52) U.S. Cl. 713/2

(57) ABSTRACT

In a computer system, upon the occurrence of a reboot command, RunTime Abstraction Services (RTAS) microcode is loaded onto a first host processor. The service processor, upon request from the RTAS microcode, then issues a command to reset all host processors other than the first host processor on which the RTAS microcode resides, and then the RTAS microcode issues a series of commands to reset all I/O adapters. Once the host processors and I/O adapters have been reset, they are initialized to a predetermined, known state. Only after the host processors and I/O adapters have been reset and initialized is the reboot request executed. By resetting all but the first host processor and the I/O adapters before executing the reboot request, all activity originating from the host processors and from the I/O drawers is terminated, so that when the reboot request is executed, the host processors and I/O drawers are ready for initialization. This allows the bypassing of the retesting of the CEC components, thereby speeding up the reboot process.

### BACKGROUND OF THE INVENTION

1. Field of the Invention

The present invention relates to multiprocessor computer systems and more particularly to improved reboot capability for large multiprocessor servers.

2. Description of the Related Art

Since the early 1980's, the personal computer industry has grown by leaps and bounds. Improving the operational speed of computer systems is demanded by consumers and is the driving force behind the rapid development and evolution of computer systems. Initially, research and development focused on increasing the speed of the single processor used by early systems; more recently, substantial effort has gone into the utilization of multiple processors in a computer system to perform parallel processing, thereby increasing the speed of operations even further.

The use of multiprocessor systems clearly has increased the operational speed obtainable in computer systems, but the complexity they introduce has also created problems. With the increase in system size and complexity, the time required to boot the system has also increased. Since these computer systems have become critical for business operation, their reliability and availability are increasingly more important. For system boot (a.k.a. “cold boot”) it is therefore essential that all the components of the system be thoroughly tested to ensure their proper operation before loading/executing business applications. This added need to extensively test a computer system at boot adversely impacts boot time.

System reboots (a.k.a. “warm boot”) when initiated from the Operating System (OS) occur while the system is already operational and thus, since the system was tested at first power-on, do not really require retesting of the system hardware. System reboots are required typically due to changes in installed software. Most computer systems today treat such warm boots as cold boots so as to initialize the system hardware to a known state (power-on state), thereby unnecessarily incurring the added time penalty of system testing performed during cold boots. An alternate means of avoiding the time penalty of a cold boot in a situation calling for a warm boot involves inclusion of added circuitry that allows software to selectively initialize system components. However, this additional circuitry increases “real-estate” requirements in the computer and also increases system costs.

To properly understand a system reboot and the problems it can present, it is important to understand the various power states and operational states of a computer, beginning from the moment that the computer is plugged into a power source. FIG. 1 depicts a typical prior art symmetric multiprocessor (SMP) system 100. The system includes a central electronic complex (CEC) 110 and plural I/O drawers 112, 114, and 116. CEC 110 includes system processors (a.k.a. host processors) 118, 120, 122 and 124, memory controller/cache 126, system memory 128, RIO hubs 130, and service processor subsystem 140. While such systems are well known, to assist in the explanation and understanding of the present invention, the system of FIG. 1 is described in more detail below.

Service processor subsystem 140 consists of an auxiliary processor (service processor) 142, and memory, I/O, and shared resources such as flash memory 144 and non-volatile random access memory (NVRAM) 146, which are accessed from the host processors via RIO hub 130, RIO to PCI bridge 132, Service Processor Interface/ISA Access Passthru 150, and PCI/ISA bridge 148.

I/O drawers 112, 114 and 116 include conventional I/O adapters (also known as I/O cards, I/O controllers, I/O bridges, or peripheral controllers) that couple any peripheral devices in the I/O drawers to the CEC. The I/O drawers may include storage media, as well as expansion slots to accommodate other storage, graphics or network adapters.

FIG. 2 is a time-based drawing illustrating the operation of the various code components involved in the operation of a typical computer system, as well as the access of the various code components to the system hardware.

The service processor 142 is essentially a small computer system that serves the computer system in which it is installed, and it is typically the first piece of hardware to receive power. Referring to FIGS. 1 and 2, at the moment the power cord of a computer system is provided with power (e.g., by providing AC/wall power), the service processor 142 goes into a “pre-standby” state whereby hardware within the service processor subsystem 140 is tested and initialized. Once the service-processor subsystem 140 hardware is initialized and the service processor is ready to perform its duties, the system is considered to be in the “standby” state, where it remains until the power switch is turned on.

The system power-on state typically occurs when the on/off switch is toggled to the “on” position or the service processor is remotely instructed to power-on the system. Initially, the computer goes through a series of steps, referred to herein as “start-up.” During this initial phase of start-up, the service processor 142 tests and initializes all of the hardware that it can access (referred to as “CEC Initialize” in FIG. 2). The service processor 142 has connectivity to most hardware internal to the CEC 110 via the JTAG/I²C bus (this access is illustrated in FIG. 2 by arrow 250) but it does not have controlling access to the I/O drawers. Thus, the service processor 142 will test and initialize the host processors 118, 120, 122 and 124, the system memory 128, and all other hardware in CEC 110, but it is unable to test or initialize the hardware contained in the I/O drawers 112, 114, and 116.

Once the CEC hardware is tested and initialized, the service processor loads the IPL microcode into the host processors, and one or more of the host processor runs the IPL microcode to identify the hardware in the I/O drawers, to initialize and test the hardware in the I/O drawers, and to identify and create a resource list of the hardware that it finds in the I/O drawers (referred to as “I/O Drawer Initialize” in FIG. 2). In other words, one of the functions of the IPL microcode is to identify, test, and initialize the hardware that is not accessible by the service processor (illustrated in FIG. 2 by arrow 252).

Ideally, when a user requests a warm boot, it should not be necessary for the service processor microcode to test the CEC. Instead, the service processor code should be able to do limited CEC initialization and load and pass control immediately to the IPL microcode. Depending on system size and configuration, this can result in almost a 50% saving in initial program loading time. However, a problem exists since at the time of a warm boot request, the I/O hardware is not typically at its deterministic initialized state; since the service processor does not have direct access to the I/O hardware it is unable to place it in a deterministic state. Specifically, at the time the user requests a warm boot, one or more of the host processors may be in the midst of an I/O transaction to or from one or more of the I/O slots located in the I/O drawers. This pending I/O activity could present unsolicited interrupts to the IPL microcode. Since IPL microcode is run at the early stages of the system start-up procedure to probe the I/O system, it is unable to distinguish between I/O interrupts generated from the probe process and I/O interrupts generated from the “stale” I/O transactions, thereby resulting in failures at system reboot.

To prevent the problems that this causes, I/O activity originating from both the host processors and the I/O devices must cease before the reboot is commenced to avoid the interrupts associated with the stale I/O transitions. Prior art systems cease this I/O activity on a reboot request by “power-cycling” the system, meaning that power to the system is cut and then restored, essentially treating the warm boot as a cold boot. This has the effect of forcing the system to run the entire start-up procedure from the beginning, even though there is no need to do so.

FIG. 3 is a flowchart illustrating an example of steps followed during a system start-up, and then a reboot, in accordance with the prior art. In FIG. 3, it is assumed that the system is already supplied with AC/wall power and thus the system is in the standby state at the time step 302 occurs. At step 302, the system is placed in the power-on state (e.g., by activation of the power-on switch), having no pending I/O or interrupts.

At step 304, the SP microcode tests the CEC hardware, and at step 305 the SP microcode initializes the CEC hardware to a known state. Then, at step 306, the IPL microcode and RTAS is loaded into system memory by the service processor, and at step 308, the remaining hardware inaccessible to the service processor is initialized via the IPL microcode, and then the operating system is loaded by the IPL microcode. At step 310, the operating system is running and the computer is operating for its intended purpose. At step 312, a query is made as to whether or not a reboot request has been implemented. If not, the process proceeds back to step 310 and the computer operates normally.

If at step 312, however, a reboot request has been issued, then at step 314, the operating system loads the RTAS onto one of the processors to execute the reboot request.

At step 316, the RTAS issues the reboot request to the service processor microcode, and at step 318, the service processor microcode power cycles the CEC and I/O hardware to initialize cease all I/O activity and processing activity, essentially cutting power from the system and then repowering the system. This causes the entire start-up procedure to commence from the beginning.

As noted above, when the system is first powered on, e.g., when it is cold booted, a considerable amount of time is expended as most of the system components are tested, initialized, and configured. The computer goes through a complete start-up sequence. In theory, however, a warm boot should take less time, since some of the early start-up procedures (e.g., hardware tests) could be bypassed. However, in view of the initialization issue described above, power-cycling is the method of choice, requiring all start-up procedures, including all of the CEC testing, to be followed.

Accordingly, it would be desirable to be able to reboot a system without having to test all of the CEC hardware over again, which can be a time-consuming process, especially for larger systems, and to do so without the need to add additional hardware to facilitate the initialization of the CEC hardware.

### SUMMARY OF THE INVENTION

In accordance with the present invention, RunTime Abstraction Services (RTAS) microcode is loaded onto a first host processor upon the initiation of a reboot request. The service processor, upon request from the RTAS microcode, then issues a command to reset all host processors other than the first host processor on which the RTAS microcode resides, and then the RTAS microcode issues a series of commands to reset all I/O adapters. Once the host processors and I/O adapters have been reset, they are initialized to a predetermined, known state. Only after the host processors and I/O adapters have been reset and initialized is the reboot request executed. By resetting all but the first host processor and the I/O adapters before executing the reboot request, all pending I/O activity is cleared, thereby clearing the conditions that may create unsolicited interrupts to microcode during the subsequent reboot. All activity originating from the host processors and from the I/O drawers is terminated, so that when the reboot request is executed, the host processors and I/O drawers are ready for initialization. This allows the bypassing of the retesting of the CEC components, thereby speeding up the reboot process.

### BRIEF DESCRIPTION OF THE DRAWINGS

FIG. 1 depicts a typical prior art symmetric multiprocessor (SMP) system;

FIG. 2 is a time-based drawing illustrating the operation of the various code components involved in the operation of a typical computer system, as well as the access of the various code components to the system hardware;

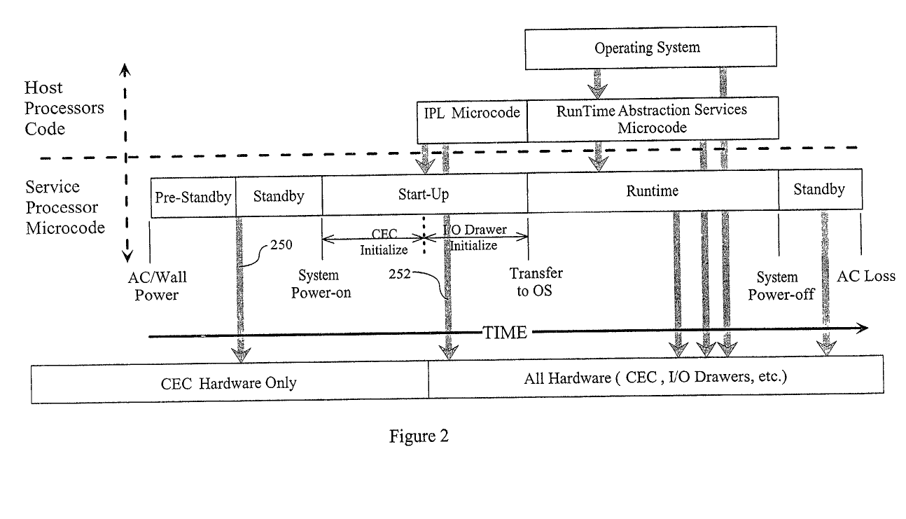

FIG. 3 is a flowchart illustrating an example of steps followed during a system start-up and reboot in accordance with the prior art; and

FIG. 4 is a flowchart illustrating the operation of the present invention.

### DETAILED DESCRIPTION OF THE PREFERRED EMBODIMENTS

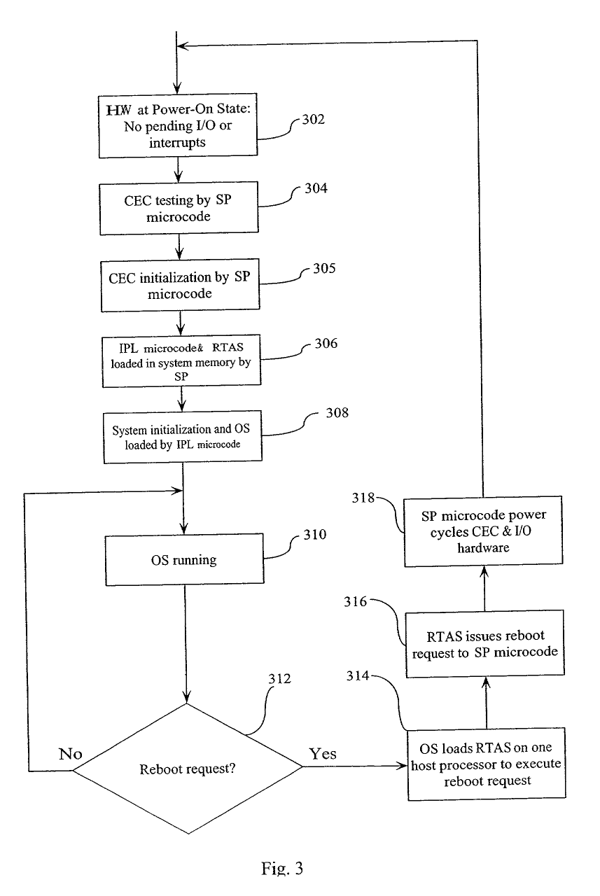

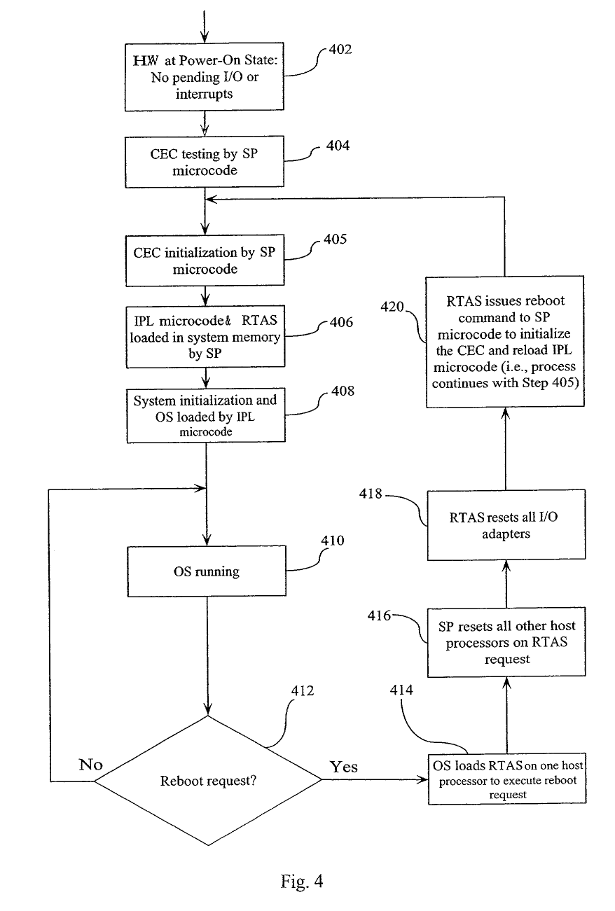

FIG. 4 is a flowchart illustrating the operation of the present invention. Steps 402 through 414 are essentially identical to steps 302 through 314 of FIG. 3. However, during a reboot request, once the operating system loads the RTAS onto one host processor at step 414 to execute the reboot request, at step 416 the service processor resets all system processors other than the processor running the RTAS request. This quiets all processing activity of the system processors that is unrelated to the reboot functionality. Since the host processor running the RTAS is running in a known state, it is unnecessary to reset that host processor.

At step 418, the RTAS resets all I/O adapters, thereby quieting all activity originating from the I/O drawers. At this point, all hardware not involved in the reboot functionality is quiesced. At step 420, instead of power cycling the system as is done in the prior art, however, the RTAS issues the reboot request to the SP microcode, and the process proceeds to step 405, bypassing steps 402 and 404. This initializes the CEC and thus the system processors, and reloads IPL microcode. By avoiding the power cycling of the prior art, considerable time saving and efficiency of operation is achieved.

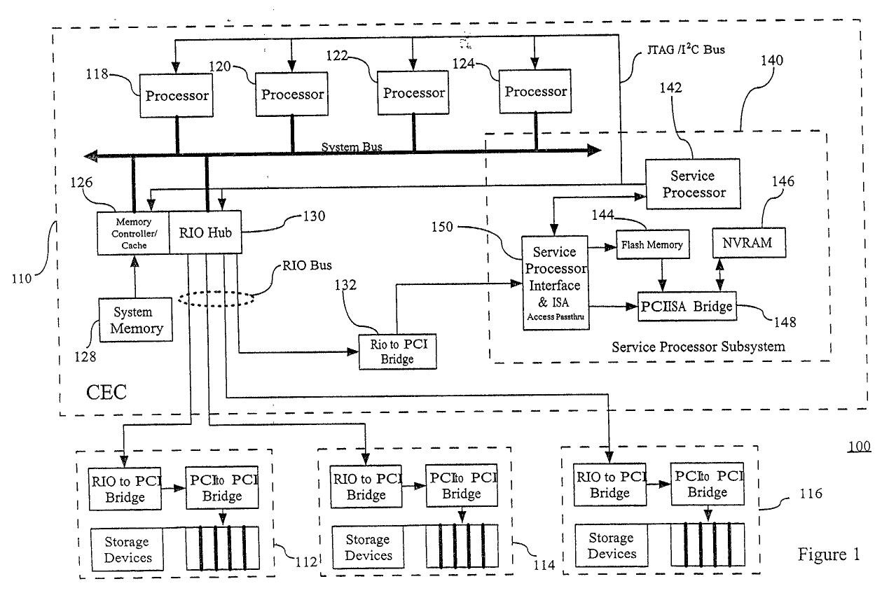

The above-described steps can be implemented using standard, well-known programming techniques. The novelty of the above-described embodiment lies not in the specific programming techniques, but in the use of the steps described to achieve the described results. Software programming code, which embodies the present invention, is typically stored in permanent storage of some type, such as Flash memory 144 of FIG. 1, and would normally be loaded into system memory 128 for execution on one or more of the host processors. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network to another computer system for use by users of such systems. The technique and methods for embodying software programming code on physical media and/or distributing software code via networks are well known and will not be further discussed herein.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method for streamlining the reboot functionality in a computer system having one or more system processors and one or more I/O adapters, comprising the steps of:
quieting all processing activity of said one or more system processors and said one or more I/O adapters that is unrelated to said reboot functionality upon the occurrence of a reboot command;
initializing all hardware of said computer system not involved in said reboot functionality upon completion of said quieting step; and
executing said reboot command upon completion of said quieting and initializing steps.

2. The method as set forth in claim 1, wherein said quieting step comprises at least the steps of:
resetting all system processors not involved in said reboot functionality; and
resetting all I/O adapters.

3. The method as set forth in claim 2, wherein said initializing step comprises at least the step of:
loading an initial program load into said system processors and I/O adapters.

4. A computer system with reboot capability, comprising:
one or more system processors, each capable of controlling the reboot functionality of said computer system;
one or more I/O adapters coupled to said one or more system processors; and
a service processor coupled to said one or more processors, said service processor configured to quiet all processing activity of said one or more system processors and said one or more I/O adapters unrelated to said reboot functionality upon the occurrence of a reboot command.

5. A computer system as set forth in claim 4, wherein said service processor resets all of said one or more system processors not involved in said reboot functionality.

6. A computer system as set forth in claim 5, wherein said service processor also resets all of said one or more I/O adapters.

7. A computer system as set forth in claim 4, wherein said system processor is further configured to initialize all hardware of said computer system not involved in said reboot functionality, after said quieting of said processing activity.

8. A computer system as set forth in claim 7, wherein said system processor is configured to load an initial program load to said system processors and said PCI adapters to effect said initialization.

9. A computer program product for a streamlining the reboot functionality in a computer system having one or more system processors and one or more I/O adapters, the computer cprogram product comprising a computer-readable storage medium having computer-readable program code, the computer-readable program code comprising:
computer-readable program code that quiets all processing activity of said one or more system processors and said one or more I/O adapters that is unrelated to said reboot functionality upon the occurrence of a reboot command;
computer-readable program code that initializes all hardware of said computer system not involved in said reboot functionality upon completion of said quieting of all processor activity; and
computer-readable program code that executes said reboot command upon completion of said quieting and initializing.

10. The computer program product as set forth in claim 9, wherein said computer-readable code that quiets all processing activity of said one or more system processors and said one or more I/O adapters that is unrelated to said reboot functionality upon the occurrence of a reboot command comprises:
computer-readable code that resets all system processors not involved in said reboot functionality; and
computer-readable code that resets all I/O adapters.

11. The method as set forth in claim 10, wherein said computer-readable code that initializes all hardware of said computer system not involved in said reboot functionality upon completion of said quieting of all processor activity comprises:
computer-readable code that loads an initial program load into said system processors and I/O adapters.
